(19) United States
(12) Patent Application Publication
(10) Pub. No.: US 2015/0288532 A1
(43) Pub. Date: Oct. 8, 2015

(54) SYSTEM AND METHOD FOR MULTI-STANDARD SIGNAL COMMUNICATIONS

(71) Applicant: SiTune Corporation, San Jose, CA (US)

(72) Inventors: Marzieh Veyseh, Los Altos, CA (US); Vahid Mesgarpour Toosi, Mountain View, CA (US)

(21) Appl. No.: 14/521,310

(22) Filed: Oct. 22, 2014

Related U.S. Application Data
(60) Provisional application No. 61/977,016, filed on Apr. 8, 2014.

(51) Int. Cl. H04L 12/28; H04B 1/00

(52) U.S. Cl. CPC H04L 12/283; H04B 1/0064; H04W 88/10

(57) ABSTRACT

Approaches enable multi-standard communications between wireless sensor nodes for wireless sensor networks. For example, approaches enable wireless communications between devices where each device may use a different wireless transmission protocols, via one or more multi-standard intermediate devices. The multi-standard intermediate device can include a multi-band radio frequency front-end unit that includes a first frequency digitalization pathway and a second frequency digitalization pathway, and a multi-band radio frequency back-end unit that includes a multi-band analog pathway to implement such approaches.

### RELATED APPLICATIONS

This application claims priority to U.S. provisional application 61,977,016, filed Apr. 8, 2014, and entitled “METHODS, SERVICES, SYSTEMS, AND ARCHITECTURES FOR HARMONY, A SMART MESH HUB FOR INTERNET OF THINGS”, the disclosure of which is hereby incorporated herein by reference in its entirety for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE TECHNOLOGY

Embodiments relate generally to method, system and apparatus for multi-standard communications between multiple wireless sensor nodes for wireless sensor networks. More specifically, disclosed are system and apparatus that enable wireless communications between devices using different wireless transmission protocols.

### BACKGROUND

In the world of ubiquitous computing, wireless sensor networks (WSNs) are becoming more important as more devices are connected to each other and the Internet. In the so-called “Internet of Things” (IoT), many devices are equipped with sensors, actuators, transceivers that need to communicate with each other. For example, in home automation, devices can make decisions based on information receive from other wirelessly connected devices without the involvement of the network owner. For instance, the coffee maker can make coffee when the motion sensor detects movement near the kitchen in the morning, or the hallway lights turn on. To enable such home automation, the devices need to exchange data wirelessly, e.g. in a two-way communication.

One of the major hurdles is that there is no unified wireless transmission standard or protocol that enables devices and applications to exchange data easily. The existing contenders (e.g. Zigbee, Z-Wave, etc.) all have their advantages and disadvantages. As a result, device manufacturers equip their products (e.g. lamps and appliances) with sensors and a selected wireless radio based on the selected wireless transmission standard. In addition, the consumers who purchase off-the-shelf products can obtain devices that employ different radio frequencies based on different wireless transmission standards.

A current solution to solve this multi-standard hurdle is to use a hub that is equipped with multiple radios transceivers to cover any possible standards that may be used in the market. The hub can communicate with all the devices, which means that all the devices are connected through the hub. For example, the hub can include multiple radio transceivers each designed to communicate in one of the popular wireless transmission standards (e.g. Zigbee, Z-Wave, Bluetooth Low Energy, 802.11ah, and ANT+). Problems of this solution include numerous and complex hardware and software need to be installed in the hub based on each of the transmission standards. The resulting hub is expensive and bulky, which limit the numbers of hubs can be deployed.

Another major hurdle is the distance limit of a single hub to connect to more distantly located devices. The more distant devices consume more energy to reach a single hub or intermediate device, which result in less battery life for the distant devices. Furthermore, each wireless transmission standard has a transmission limit in distance or areas.

Thus, there is a need to provide a multi-standard wireless sensor network via a cost-effective, efficient and compact wireless intermediate device that can communicate with devices based on different wireless transmission standards. Furthermore, such an intermediate device can also communicate with multiple intermediate devices to form a flexible and expandable mesh network to cover a large communication space.

### BRIEF DESCRIPTION OF THE DRAWINGS

Various embodiments or examples (“examples”) of the technology are disclosed in the following detailed description and the accompanying drawings:

FIG. 1 is a perspective view of an example of a mesh network including multiple intermediate devices and connected devices, according to some embodiments;

FIG. 2 is a schematic diagram of an example of a multi-standard front end unit of an intermediate device, according to some embodiments;

FIG. 3 is a block diagram of an example of a digital signal process (DSP) associated with a multi-standard intermediate device, according to some embodiments;

FIG. 4 is a schematic diagram of an example of a multi-standard end unit of an intermediate device, according to some embodiments;

FIG. 5 is a block diagram of an example of a multi-standard intermediate device, according to some embodiments;

FIG. 6 is an example flow diagram for session management system, illustrating the optional steps via a client computing device; and

FIG. 7 illustrates an exemplary computing platform disposed in a multi-band wireless intermediate device, according to some embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Although the foregoing examples have been described in some detail for purposes of clarity of understanding, the above-described inventive techniques are not limited to the details provided. There are many alternative ways of implementing the above-described techniques. The disclosed examples are illustrative and not restrictive.

Various embodiments relate to a multi-standard intermediate device for communicating with multiple devices based on different wireless transmission standards. The multi-standard intermediate device can be used in a broad filed of applications including home automation, heath care, emergency response and intelligent shopping.

Various embodiments also be used to create a clustered mesh network that aggregates separate networks into one mesh network. A wireless mesh network is a communication network including radio nodes organized in a mesh topology. Mesh infrastructure can transmit data over large distances by splitting the distance into multiple hops between the intermediate nodes or devices. Intermediate devices can enhance the signal and route data between different intermediate devices by making forwarding decisions based on the forwarding tables or other network information.

In some embodiments, the multi-standard intermediate device can include a receiver radio frequency (RF) front end chip based on a concurrent multi-standard reception (CMS). The CMS can enable the chip to concurrently receive all radio transmissions in different radio frequency ranges/bands when each transmission occupies a different part of the band and all the transmissions are not overlapping partially through digital signal processing (DSP). The CMS can also enable the chip to concurrently receive a sub-1 GHz radio transmission and a 2.4-2.5 GHz radio transmission via a sub-1 GHz antenna and a 2.4-2.5 GHz antenna, respectively. In some embodiments, the multi-standard intermediate device can demodulate all transmissions based on different transmission standards via multiple demodulators each for a specific transmission standard. Accordingly, the CMS can eliminate the need of multiple wireless radios.

In some embodiments, the multi-standard intermediate device can include a digital signal processor (DSP) for conditioning the received data. The DSP can include multiple digital process modules each corresponding to a specific transmission standard (e.g. Zigbee, Z-Wave, etc.) for conditioning the digital data. For any radio signals received in one of the two radio frequency bands (800M-1 GHz and 2.4-2.5 GHz), the DSP can determine a corresponding digital process module corresponding to the received radio signals based on a specific radio frequency range. For example, a Z-wave radio signals at 908 MHz is associated with a Z-wave digital process module. Through this approach, the multi-standard intermediate device can receive an entire radio band (e.g. a sub-1 G radio band or a 2.4 G radio band) and separate each individual radio transmission in the multi-module DSP. Thus, the multi-standard intermediate device can concurrently process multiple radio transmissions each sitting in a different carrier frequency without multiple radio receivers.

In addition, the DSP can include a plurality of demodulators each corresponding to a specific transmission standard for demodulating the signals. (e.g. Z-wave demodulator).

In some embodiments, the DSP can also provide digital hopping in the radio frequencies to remove the need for frequency hopping phase lock loops (PLLs) for some transmission standards.

In some embodiment, the multi-standard intermediate device can include a transmitter radio frequency (RF) end chip that can be used to re-transmit the received signals. In some embodiment, the re-transmission can enhance the received signals and make them travel a further distance.

In some embodiments, the multi-standard intermediate device can enable devices based on different transmission standards to communicate with each other (e.g. exchange data). For example, for a Z-wave device to communicate with a Zigbee device, the multi-standard intermediate device can receive Z-wave radio signals and convert them to Zigbee radio signals.

In addition, several different types of MACs can be used in the multi-standard intermediate device. For example, the multi-standard intermediate device can employ multiple medium access controls (MAC) for handling communications based on multiple transmission standards. The multi-standard intermediate device can further include a multi-standard MAC coordinator that can centralize and coordinate the communications between the multiple MACs. Furthermore, the multi-standard intermediate device can include an inter-device MAC to manage the communications between different multi-standard intermediate devices, e.g. packet routing.

In addition, in some embodiments, several multi-standard intermediate devices can communicate with each other to form a flexible and expandable mesh network that can cover a larger geographical area as well as connect more devices. In some embodiments, the multi-standard intermediate device can repeat the received data to enable the data to cover a further distance. In addition, in a multi-center mesh network, devices can connect to a closer multi-standard intermediate device to conserve energy for data transmission.

In some embodiments, a multi-standard intermediate device can be an internet gateway that provides internet access to multiple radio nodes as well as other multi-standard intermediate devices. In addition, the multi-standard intermediate device can provide internet access for the multiple intermediate-device mesh network.

Furthermore, in some embodiments, a multi-standard intermediate device can connect to a control device such as an electronic device (e.g. a smart phone, a tablet or a computer) to enable a centralized control with or without the network owner's interference. Such a control device can run applications to manage the multi-standard intermediate device as well as the wireless network. For example, the control device can analyze the collected data from the radio notes and issue commands to the radio nodes based on these data. (e.g. enable the coffee machine to brew coffee when the motion sensor senses movement in the kitchen). In some embodiments, the multi-standard intermediate device can function as the control device. Yet in some embodiments, the control function can be distributed in each of the radio nodes. Thus, each of the radio nodes can be autonomous and intelligent.

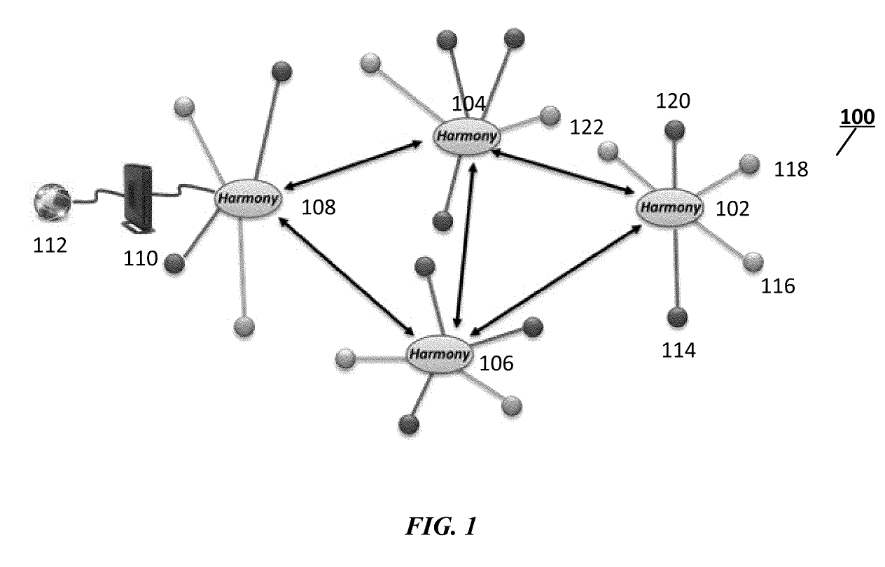

FIG. 1 depicts an example of a mesh network including multiple intermediate devices and their connected devices, according to some embodiments. A multi-center mesh network 100 can include one or more multi-standard intermediate device (e.g. 102, 104, 106 and 108) to form a wireless sensor network. Each of the multiple-standard intermediate devices can be elected and operate as a cluster head of the mesh network 100. A cluster head can group sensor nodes (e.g. 114, 116, 118, 120 and 122) into clusters and collect all the data provided by the sensor nodes to a base/control station such as a computer or a tablet (not shown). In addition, different multi-center intermediate device can alternate as a cluster head to reduce energy consumption of each device.

Different sensor nodes (e.g. 114, 116, 118, 120 and 122) can be used in multi-center mesh network 100. Examples of sensor nodes include smart thermometers, cameras, humidity meters, GPS sensors, gyroscopes, etc. Sensor nodes can monitor environmental conditions such as temperature, humidity, sound and location. Each of these sensor nodes is equipped with a radio transceiver based on a selected transmission standard, a microcontroller and an energy source (e.g. battery).

In some embodiment, a sensor node can conduct a two-way communication with another sensor node, an intermediate multi-standard device, or a control device/base station. The two-way communication enables the sensor node to make intelligent and autonomous decisions based on the collected data.

According to some embodiments, two groups of transmission standards are generally available for wireless network communication, wherein each of the transmission standards has its advantages and disadvantages that are known in the art. The first group uses the industrial, scientific and medical (ISM) radio bands from 2.4 to 2.485 GH; the second group uses the UHF band ranging from 755 MHz to 1 GHz or the sub-1 G band. Examples of the first group (2.4 G band) include Zigbee, Bluetooth (BL), and Bluetooth Low Energy (BLTE). Examples of the second group (sub-1 G band) include Z-wave, EnOcean, 802.11ah, and Insteon. In addition, other industrial transmission protocols can be implemented in the multi-stand intermediate device, such as TCP/IP based protocols.

Particularly, Zigbee is a major transmission standard that has certain advantageous characteristics. For example, Zigbee offers a range of up to 10 m with 16 channels when each channel has 2 MHz Bandwidth and they are 5 MHz apart. One channel is used for each communication path with Direct Sequence Spread Spectrum. For each Wi-Fi channel, there are four overlapping ZigBee channels. ZigBee allows dynamic channel selection, a scan function steps through a list of supported channels in search of beacon, receiver energy detection, link quality indication. A feature called frequency agility is specified in the ZigBee standard to improve the robustness of ZigBee networks. According to this function, if interference is detected and reported in the current channel, a ZigBee network may move to a clear channel. The frequency agility function enables easier usage of these extra channels. For example, when a network is first formed the node seeks a channel with the least noise or traffic. If overtime extra traffic appears or noise becomes present, the host application scans for a better channel and moves the whole network to the new channel, thus allowing the network to adapt overtime to changing RF environments.

In some embodiments, multi-standard intermediate device 108 can use the specific Zigbee characteristics to enable concurrent signal processing. For example, multi-standard intermediate device 108 can implement new protocols that allow multiple Zigbee devices to use different unoccupied Zigbee channels at the same time. Multi-standard intermediate device 108 can receive and demodulate these non-overlapping channels. Thus, the devices that use non-overlapping channels do not need to wait for their turn to use the medium when the intermediate device's Zigbee radio is engaged with another device. This feature can lead to lower transmitter active time, faster channel access, and ultimately less power consumption.

As shown in FIG. 1, multi-standard intermediate device 108 can be an internet gateway to provide internet access to multi-center mesh network 100. Multi-standard internet device 108 can be connected to a network device 110 (e.g. router, switch, hub, etc.) which can provide World Wide Web service 112 to multi-center mesh network 100. In some embodiments, multi-standard intermediate device 108 can incorporate functions of routers and switches and directly provide Internet access to multi-center mesh network 100.

Different wireless sensor network topologies can be applied in multi-center mesh network 100. Examples of the wireless sensor network topologies include a single hop topology and a multi-hop topology (flat or cluster). In a single hop architecture, all sensor nodes can communicate with the base station or control station directly, which makes it difficult for a network that needs to cover a large area (as the base station is inaccessible). In a multi-hop cluster architecture, as shown in FIG. 1, cluster heads (e.g. 102) can collect data from sensor nodes (e.g. 122) and transmit data to the base station either directly or through multiple hops via other cluster heads (e.g. 104). The multi-hop cluster architecture includes multiple advantages, including reducing power consumption of sensor nodes, and sharing wireless medium with multiple sensor nodes. Thus, the multi-hop cluster architecture is often preferred in a large wireless sensor network.

Furthermore, each of the multi-standard intermediate devices 102, 104, 106 and 108 can communicate with each other through a selected wireless transmission protocols. In some embodiments, such communications between the devices can repeat the signals and send it to a further distance, thus creating a mesh network that covers a larger area. In some embodiments, such communications can route the data provided by sensor nodes to a cluster head for centralized data collection and management.

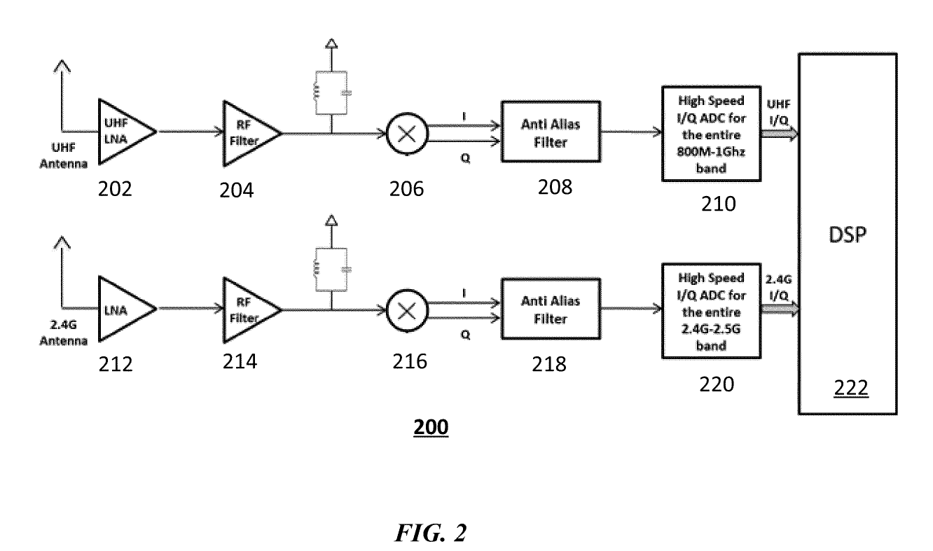

FIG. 2 is a schematic diagram of a front end unit of an intermediate device. A front end unit can digitalize the received analog signals for further processing in DSP. In some embodiments, there are two digitalization pathways in the front end unit 200, including one pathway for the 800M-1 GHz radio bands and another pathway for the 2.4 G-2.5 G radio bands. Each of the digitalization pathways has a corresponding antenna for the targeted radio bands. (e.g. a 800M-1 GHz antenna, and a 2.4 G antenna). For example, the 800M-1 GHz digitalization pathway can include a UHF antenna to receive selected radio signals, a UHF low noise amplifier (LNA) 202 to amplify the received radio signals, a RF filter 204 to tuned to the band of interest in the received radio signals, a mixer 206 to convert the signal down to an intermediate frequency, an anti-alias filter 208 to remove folding effects, a high-speed Analog Digital Converter (ADC) 210 to converts the whole 800M-1 GHz radio band to a corresponding digital stream. Similarly, the 2.4 G-2.5 G digitalization pathway can include an 2.4 G antenna, a LNA 212, a RF filter 214, a mixer 216, an anti-alias filter 218, and a high-speed ADC 220. The digitalized stream of the radio bands can be delivered to a DSP for further processing.

In some embodiments, the two digitalization pathways can individually and concurrently receive and process radio signals when the two radio carrier frequency ranges do not overlap with each other.

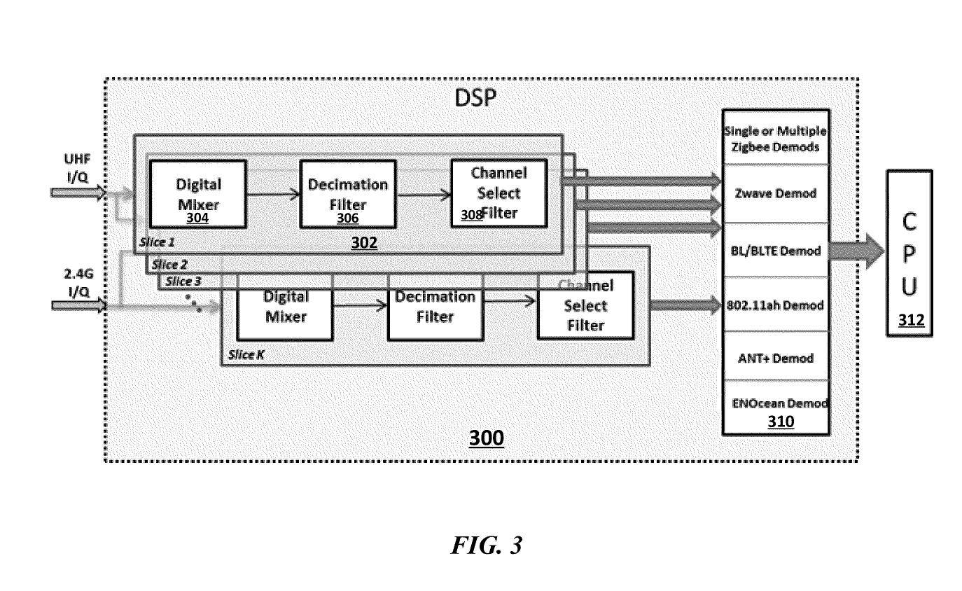

FIG. 3 is a block diagram of an example of a digital signal process (DSP) associated with a multi-standard intermediate device. In some embodiments, DSP 300 can include a multi-standard MAC coordinator to manage the concurrent communication from/to the hub through slicing or modulating each received radio signals according to its radio carrier frequency range. For example, the multi-standard MAC coordinator can determine and associate multiple digital process modules/slices (e.g. 302), wherein each module/slice is associated with an identified sensor node in the wireless sensor network.

In some embodiments, digital process module 302 can condition a received digital radio signals. For example, digital process module 302 can include a digital mixer 304, a decimation filter 306, and a channel select filter 308 to separate each individual signal channel from others. After being processed at the digital process module, the digitally separated and conditioned signal channel is delivered to the corresponding demodulator for demodulation.

As shown in FIG. 3, a plurality of standard specific demodulators can be installed in the multi-standard intermediate device. For example, the device can include an EnOcean demodulator 310, an ANT+ demodulator, a 802.11ah demodulator, a BL/BLTE demodulator, and a Zwave demodulator. In some embodiments, the device can have a single Zigbee demodulator or multiple Zigbee demodulators for different radio channels based on Zigbee.

Accordingly, the device can include a plurality of standard specific medium access control (MAC) for each commonly used standard. Each stand specific MAC can manage the data generated by each of the standard specific demodulator and can. For example, the device can include a Zware MAC, a BL/BLTE MAC, a 802.11ah MAC, an ANT MAC, an EnOcean MAC. Furthermore, the device can include a Zigbee MAC or multiple Zigbee MACs, or a Multi-Zigbee MAC coordinator. Furthermore, each standard specific MAC can communicate with the Multi-standard MAC coordinator as described herein.

Furthermore, the multi-standard intermediate device can include an inter-device MAC that coordinates the communication between multiple devices.

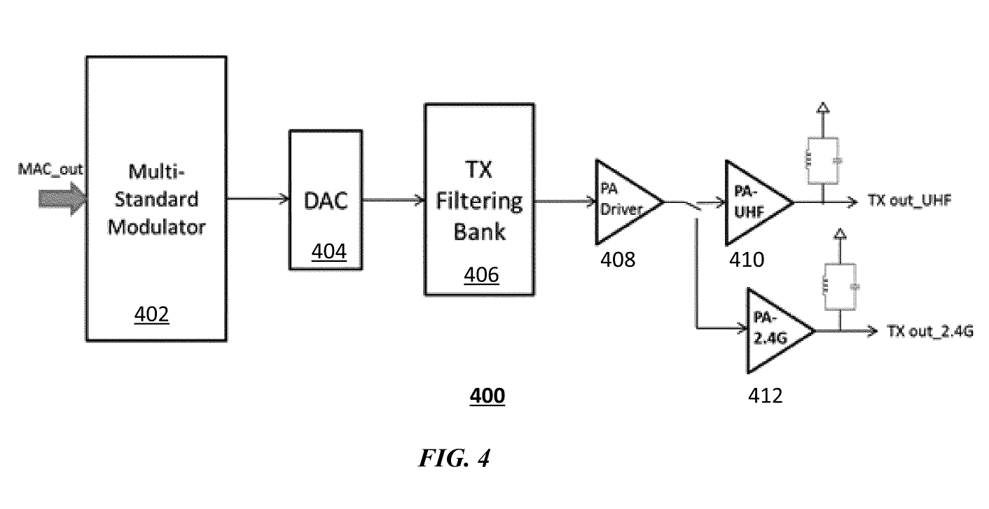

FIG. 4 is a schematic diagram of an end unit of an intermediate device. The end unit of an intermediate device 400 can re-transmit the received radio signals either to another intermediate device or to the base station. As shown in FIG. 4, the end unit 400 can include a multi-band analog pathway that is shared by various radio signals in different transmission frequency ranges. In some embodiments, the end unit can include a multi-standard modulator 402 to modulate the signals with a selected carrier frequency based on a selected transmission standard. The modulated digital stream is then delivered to a DAC 404, a TX filtering bank 406 and a PA driver 408. PA driver 408 can drive a UHF power amplifier 410 for the 800M-1 GHz radio bands and a 2.4 G power amplifier 412 for the 2.4 G-2.5 G radio bands.

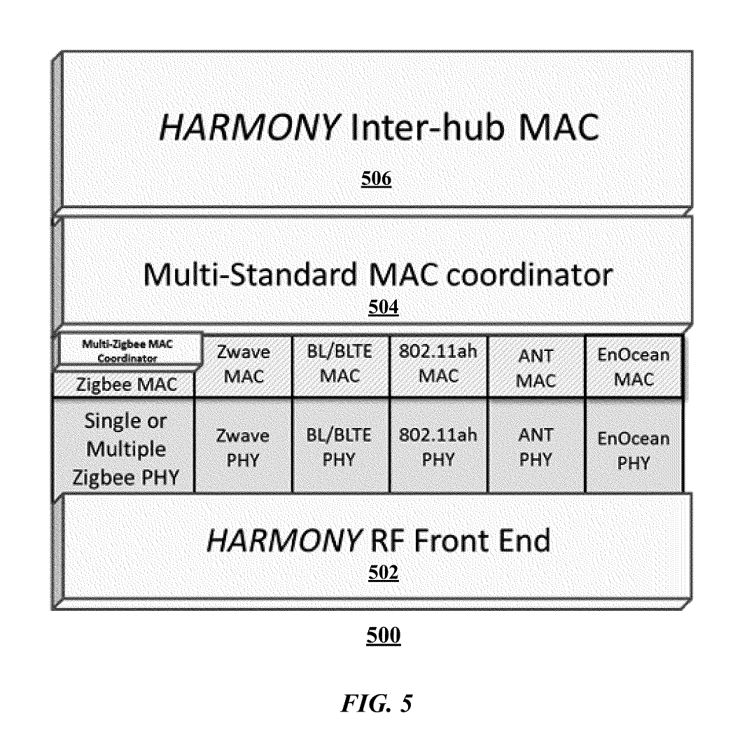

FIG. 5 is a layered architecture of a multi-standard intermediate device, according to some embodiments. A multi-standard intermediate system 500 can include a RF front end 502, a multiple-standard MAC coordinator 504, an inter-hub MAC 506 and a plurality of standard specific physicals (e.g. demodulators) and a plurality of standard specific MACs.

In some embodiments, RF front end 502 can digitalize the received analog signals for further processing in DSP. As shown in FIG. 5, multi-standard intermediate system 500 can employ multiple MACs to manage data from different radio signals. For example, a plurality of standard specific MACs (e.g. Zwave MAC) can be used to access data in a Zwave radio band. Furthermore, a multi-standard MAC coordinator 504 can centralize and coordinate the communications between the multiple standard specific MACs. In some embodiments, multi-standard MAC coordinator 504 can handle the network set up stage and control communication to/from the connected devices within the network. In addition, an inter-hub MAC 506 can manage the re-transmission of received signals, e.g. packet routing.

In some embodiments, since multiple Zigbee channels can be received at the same time, multi-standard intermediate system 500 can employ a multi-Zigbee MAC coordinator 504 that uses this feature to reduce channel access time and energy consumption.

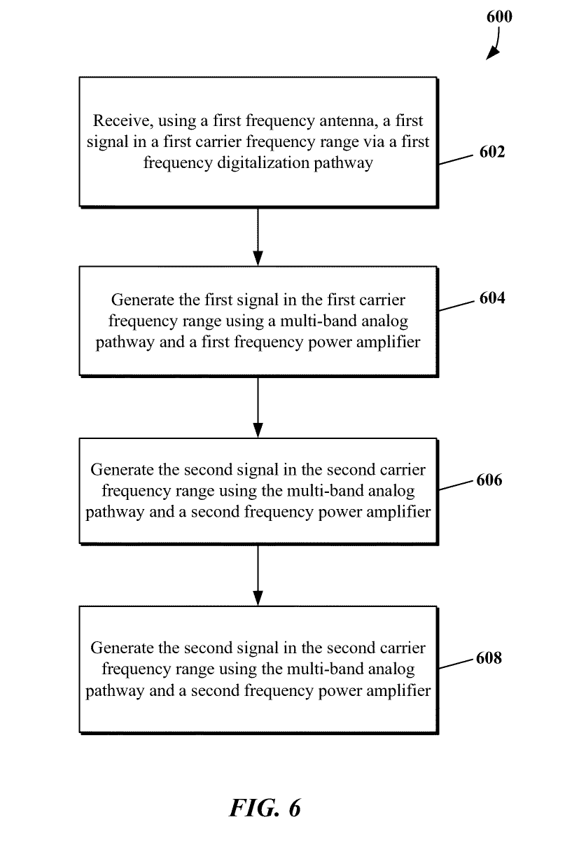

FIG. 6 is an example flow diagram for session management system, illustrating the optional steps via a client computing device. It should be understood that there can be additional, fewer, or alternative steps performed in similar or alternative orders, or in parallel, within the scope of the various embodiments unless otherwise stated. At step 602, flow diagram 600 begins with receiving, using a first frequency antenna, a first signal in a first carrier frequency range via a first frequency digitalization pathway. At step 604, flow diagram 600 follows with receiving, concurrently using a second frequency antenna, a second signal in a second carrier frequency range that does not overlap with the first carrier frequency range via a second frequency digitalization pathway. At step 606, flow diagram 600 follows with generating the first signal in the first carrier frequency range using a multi-band analog pathway and a first frequency power amplifier. At step 608, flow diagram 600 ends with generating the second signal in the second carrier frequency range using the multi-band analog pathway and a second frequency power amplifier

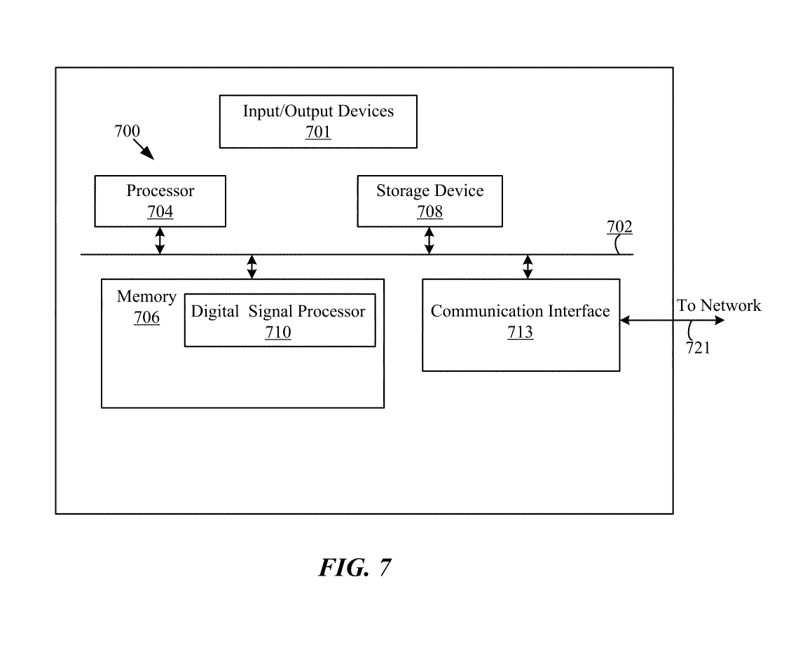

FIG. 7 illustrates an exemplary computing platform disposed in a multi-band wireless intermediate device, according to some embodiments. In some examples, computing platform 700 may be used to implement computer programs, applications, methods, processes, algorithms, or other software to perform the above-described techniques. Computing platform 700 includes a bus 702 or other communication mechanism for communicating information, which interconnects subsystems and devices, such as processor 704, system memory 706 (e.g., RAM, etc.), storage device 708 (e.g., ROM, etc.), a communication interface 713 (e.g., an Ethernet or wireless controller, a Bluetooth controller, etc.) to facilitate communications via a port on communication link 721 to communicate, for example, with a session monitoring device or a session server, including mobile computing and/or communication devices with processors. Processor 704 can be implemented with one or more central processing units (“CPUs”), such as those manufactured by Intel® Corporation, or one or more virtual processors, as well as any combination of CPUs and virtual processors. Computing platform 700 exchanges data representing inputs and outputs via input-and-output devices 701, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 700 performs specific operations by processor 704 executing one or more sequences of one or more instructions stored in system memory 706, and computing platform 700 can be implemented in a client-server arrangement, peer-to-peer arrangement, or as any mobile computing device, including smart phones and the like. Such instructions or data may be read into system memory 706 from another computer readable medium, such as storage device 708. In some examples, hard-wired circuitry may be used in place of or in combination with software instructions for implementation. Instructions may be embedded in software or firmware. The term “computer readable medium” refers to any tangible medium that participates in providing instructions to processor 704 for execution. Such a medium may take many forms, including but not limited to, non-volatile media and volatile media. Non-volatile media includes, for example, optical or magnetic disks and the like. Volatile media includes dynamic memory, such as system memory 706.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 702 for transmitting a computer data signal.

In some examples, execution of the sequences of instructions may be performed by computing platform 700. According to some examples, computing platform 700 can be coupled by communication link 721 (e.g., a wired network, such as LAN, PSTN, or any wireless network) to any other processor to perform the sequence of instructions in coordination with (or asynchronous to) one another. Computing platform 700 may transmit and receive messages, data, and instructions, including program code (e.g., application code) through communication link 721 and communication interface 713. Received program code may be executed by processor 704 as it is received, and/or stored in memory 706 or other non-volatile storage for later execution.

In the example shown, system memory 706 can include various modules that include executable instructions to implement functionalities described herein. In the example shown, system memory 706 includes a digital signal processor 710, which can be configured to provide one or more functions described herein.

Although the foregoing examples have been described in some detail for purposes of clarity of understanding, the above-described inventive techniques are not limited to the details provided. There are many alternative ways of implementing the approaches for various approaches for embodiments described herein and the disclosed examples are illustrative and not restrictive.

Although the foregoing examples have been described in some detail for purposes of clarity of understanding, the above-described inventive techniques are not limited to the details provided. There are many alternative ways of implementing the approaches for various approaches for embodiments described herein and the disclosed examples are illustrative and not restrictive.

What is claimed is:

1. A multi-band wireless device, comprising:
a first multi-band radio frequency front component configured to:
receive, using a first frequency antenna, a first signal in a first carrier frequency range via a first frequency digitalization pathway,
receive, concurrently using a second frequency antenna, a second signal in a second carrier frequency range that does not overlap with the first carrier frequency range via a second frequency digitalization pathway; and
a second multi-band radio frequency component configured to:
generate the first signal in the first carrier frequency range using a multi-band analog pathway and a first frequency power amplifier, and
generate the second signal in the second carrier frequency range using the multi-band analog pathway and a second frequency power amplifier.

2. The multi-band wireless device of claim 1, further comprising:
a digital signal processor associated with the first multi-band radio frequency component, the digital signal processor configured to
generate a digitalized first signal corresponding to the first signal using the first frequency digitalization pathway; and
generate a digitalized second signal corresponding to the second signal using the second frequency digitalization pathway.

3. The multi-band wireless device of claim 2, wherein the first antenna comprises a 800 MHz-1 G antenna, and the second frequency antenna comprises a 2.4 GHz-2.5 GHz antenna, and wherein the first frequency power amplifier comprises a 800 MHz-1 G power.

4. The multi-band wireless device of claim 2, wherein the digital signal processor is further configured to
demodulate the digitalized first signal using a first demodulator associated with a first transmission protocol; and
demodulate the digitalized first second signal using a second demodulator associated with a second transmission protocol.

5. The multi-band wireless device of claim 1, wherein the first carrier frequency range comprises a radio frequency range of 800 to 1 GHz, the second carrier frequency range comprises a radio frequency range of 2.4 to 2.5 GHz.
amplifier, and the second frequency power amplifier comprises a 2.4 GHz-2.5 GHz power amplifier.

6. The multi-band wireless device of claim 1, wherein the first frequency digitalization pathway comprises a first low noise amplifier, a first filter, a first mixer, a first anti alias filter, and a first ADC, and wherein the second frequency digitalization pathway comprises a second low noise amplifier, a second filter, a second mixer, a second anti alias filter, and a second ADC.

7. The multi-band wireless device of claim 1, wherein the first frequency digitalization pathway comprises a first digital processing module configured to condition the digitalized first signal, the first digital processing module comprising a first digital mixer, a first decimation filter and a first channel select filter, and wherein the second frequency digitalization pathway comprises a second digital processing module configured to condition the digitalized second signal, the second digital processing module comprising a second digital mixer, a second decimation filter and a second channel select filter.

8. The multi-band wireless device of claim 7, wherein each of the first digital processing module and the second digital processing module is one of a plurality of digital processing modules corresponding to a plurality of specific transmission protocols.

9. The multi-band wireless device of claim 1, wherein the multi-band analog pathway comprises a multi-band modulator, a DAC, a filter, and a driver.

10. A system for receiving and transmitting multi-band signals, comprising:
a multi-band radio frequency front-end unit including a first frequency digitalization pathway associated with a first antenna and a second frequency digitalization pathway associated with a second antenna, the multi-band radio frequency front-end unit configured to:
receive a signal in a carrier frequency range using one of the first antenna or the second antenna that is configured to receive signals in the carrier frequency range,
generate a digitalized signal using one of the first frequency digitalization pathway or the second frequency digitalization pathway corresponding to the first antenna or the second antenna that receives the signal;
a digital signal processor associated with the multi-band radio frequency front-end unit, the digital signal processor configured to:
condition the digitalized signal using a digital processing module corresponding to a specific transmission protocol to generate a conditioned signal, and
demodulate the conditioned signal using a demodulator associated with the specific transmission protocol; and
a multi-band radio frequency end unit including a multi-band analog pathway associated with a first frequency power amplifier and a second frequency power amplifier, the multi-band radio frequency end unit configured to:
generate the signal in the carrier frequency range using the multi-band analog pathway and one of the first frequency power amplifier or the second frequency power amplifier that is configured to generate signals in the carrier frequency range.

11. The system of claim 10, wherein the multi-band radio frequency front-end unit is further configured to
receive, concurrently, a second signal in a second carrier frequency range that does not overlap with the carrier frequency range using another one of the first antenna or the second antenna that is configured to receive signals in the second carrier frequency range; and
generate a second digitalized signal using the another one of the first frequency digitalization pathway or the second frequency digitalization pathway corresponding to the another one of the first antenna or the second antenna that is configured to receive signals in the second carrier frequency range.

12. The system of claim 10, wherein the system is one of a plurality of systems configure to communicate with each other and form a mesh network.

13. The system of claim 10, wherein the specific transmission protocol is one of a plurality of transmission protocols including Zigbee, Bluetooth, ANT+, Z-Wave, EnOcean, 802.11ah, Insteon and other unlicensed bands.

14. The system of claim 10, further comprising a multi-standard medium access control (MAC) coordinator, the MAC coordinator configured to
enable the system to process the signal according to the specific transmission protocol.

15. The system of claim 10, further comprising an inter-system medium access control (MAC), the inter-system MAC coordinator configured to coordinate the system to communicate with another system.

16. The system of claim 10, further comprising a plurality of demodulators corresponding to a plurality of transmission protocols.

17. A method for using a multi-band device, comprising:
receiving, concurrently, one or more radio signals in one or more carrier frequency ranges using one of a first antenna or a second antenna that is configured to receive signals in the one or more carrier frequency ranges, the first antenna and the second antenna both being associated with a multi-radio frequency front-end unit;
generating one or more digitalized signals corresponding to the one or more radio signals using one of a first frequency digitalization pathway or a second frequency digitalization pathway corresponding to the one of the first antenna or the second antenna that receives the one or more radio signals;
determining one or more digital processing modules corresponding to the one or more digitalized signals, each of the one or more digital processing modules being associated with a specific carrier frequency range; and
generating the one or more radio signals in the one or more carrier frequency ranges using a multi-band analog pathway and one of a first frequency power amplifier or a second frequency power amplifier that is configured to generate the one or more radio signals in the one or more carrier frequency ranges, the first frequency power amplifier and the second frequency power amplifier both being associated with a multi-band radio frequency back-end unit.

18. The method of claim 17, further comprising
processing the one or more digitalized signals using the determined one or more digital process modules, each of the one or more digitalized signals corresponding to a respective digital process module of the one or more digital process modules.

19. The method of claim 17, wherein at least a portion of the one or more carrier frequency ranges corresponds to one of a plurality of transmission protocols.

20. The method of claim 17, further comprising
demodulating the one or more digitalized signals using one or more demodulators, each of the one or more demodulators corresponding to a respective carrier frequency range of the one or more carrier frequency ranges.
